(19) United States
(12) Patent Application Publication
(10) Pub. No.: US 2014/0103275 A1
(43) Pub. Date: Apr. 17, 2014

(54) CLAW HAMMER CAPABLE OF ADJUSTING AN ANGLE

(71) Applicant: LUCKY-BRAND INDUSTRIAL CO., LTD., Taichung City (TW)

(72) Inventor: Chien-Cheng CHEN, Taichung City (TW)

(73) Assignee: LUCKY-BRAND INDUSTRIAL CO., LTD., Taichung City (TW)

(21) Appl. No.: 13/649,741

(22) Filed: Oct. 11, 2012

(51) Int. Cl. B25D 1/04

(52) U.S. Cl. 254/26 R

(57) ABSTRACT

A claw hammer capable of adjusting an angle comprises a body having a handle rod and a hammerhead connected to each other, a nail-drawing piece having a joining section and a nail-drawing section connected to each other and a fixing piece disposed in the nail-drawing piece and the body to fix them together. The hammerhead has a tooth portion distributed about a central axis. The joining section has a tooth portion distributed about a central axis and engaged with the tooth portion of the body. Thereby, the nail-drawing piece can be connected with the hammerhead into a form similar to a conventional hammerhead, and the nail-drawing piece can also change an angle thereof with respect to the body by moving away from or closer to the handle rod so that the claw hammer is more suitable for use in a space which is narrow or has an obstacle therein.

### BACKGROUND OF THE INVENTION

1. Technical Field

The present invention relates to hammering tools having the nail-drawing function, and more particularly, to a claw hammer capable of adjusting an angle.

2. Description of Related Art

A conventional hammering tool such as a hammer mainly comprises a hammerhead and a handle rod. Two ends of the hammerhead are usually a hammering portion and a nail-drawing portion respectively, and the handle rod extends outwards substantially perpendicular to the hammerhead from a middle section of the hammerhead. A user may hold the handle rod to wield the hammering tool towards a target so that the hammering portion of the hammerhead hits the target. The user may also place the hammerhead against a surface of an object to use the nail-drawing portion to clamp a nail nailed in the surface, and then apply a force on the handle rod to draw the nail out of the object by means of the nail-drawing portion according to the lever principle.

The hammering portion and the nail-drawing portion of the conventional hammerhead are integrally connected into the form of an elongated column, and both angles of the hammering portion and the nail-drawing portion with respect to the handle rod are fixed. However, a space which is sufficient to receive the hammerhead and allows the handle rod to swing therein is required around the nail to be drawn. Therefore, the nail-drawing function of the conventional hammering tool is difficult to be used in a space (e.g., a corner of a wall) which is excessively narrow or has an obstacle therein, and still needs to be improved.

### BRIEF SUMMARY OF THE INVENTION

In view of the aforesaid shortcoming, a primary objective of the present invention is to provide a claw hammer capable of adjusting an angle, which is more suitable for use in a space which is narrow or has an obstacle therein.

To achieve the aforesaid objective, the present invention provides a claw hammer capable of adjusting an angle, which comprises a body, a nail-drawing piece and a fixing piece. The body has a handle rod and a hammerhead connected to the handle rod. The hammerhead has a central axis and a tooth portion distributed about the central axis. The nail-drawing piece has a joining section and a nail-drawing section which are connected to each other. The joining section has a central axis and a tooth portion distributed about the central axis. The tooth portion of the nail-drawing piece is engaged with the tooth portion of the body. The fixing piece is disposed in the nail-drawing piece and the body so that the nail-drawing piece and the body are fixed to each other.

Accordingly, a user can adjust a relative angle between the body and the nail-drawing piece simply by releasing the function of the fixing piece that fixes the nail-drawing piece and the body together. Thus, the nail-drawing piece can be connected with the hammerhead into a form that is similar to a conventional hammerhead, and the nail-drawing piece can also change an angle thereof with respect to the body by moving the nail-drawing section thereof away from or closer to the handle rod. Thereby, the claw hammer is more suitable for use in a space which is narrow or has an obstacle therein.

The detailed construction, features, assembling or operating manners of the claw hammer capable of adjusting an angle of the present invention will be described in the following DETAILED DESCRIPTION OF THE EMBODIMENTS OF THE INVENTION. However, it shall be appreciated by those of ordinary skill in the art that, the detailed description and specific embodiments enumerated for implementation of the present invention are only intended to illustrate the present invention but not to limit the scope of the present invention.

### BRIEF DESCRIPTION OF THE SEVERAL VIEWS OF THE DRAWINGS

FIG. 1 is a perspective assembly view of a claw hammer capable of adjusting an angle according to a first preferred embodiment of the present invention;

FIG. 2 and FIG. 3 are perspective exploded views of the claw hammer capable of adjusting an angle according to the first preferred embodiment of the present invention;

FIG. 4 is a perspective assembly view of the claw hammer capable of adjusting an angle according to the first preferred embodiment of the present invention, which illustrates an aspect where a nail-drawing piece of the claw hammer is further away from a handle rod as compared to that shown in FIG. 1;

FIG. 5 is a perspective assembly view of the claw hammer capable of adjusting an angle according to the first preferred embodiment of the present invention, which illustrates an aspect where the nail-drawing piece of the claw hammer is closer to the handle rod as compared to that shown in FIG. 1;

FIG. 6 and FIG. 7 are schematic views of the claw hammer capable of adjusting an angle according to the first preferred embodiment of the present invention which is used to draw a nail located at a corner of a wall;

FIG. 8 is a schematic view of the claw hammer capable of adjusting an angle according to the first preferred embodiment of the present invention which is used as a tommy bar;

FIG. 9 is a side view of a claw hammer capable of adjusting an angle according to a second preferred embodiment of the present invention, which illustrates an aspect where the claw hammer is used to clamp a nut; and

FIG. 10 is similar to FIG. 9, but illustrates an aspect where the claw hammer is used to clamp a nut with a smaller size.

### DETAILED DESCRIPTION OF THE EMBODIMENTS OF THE INVENTION

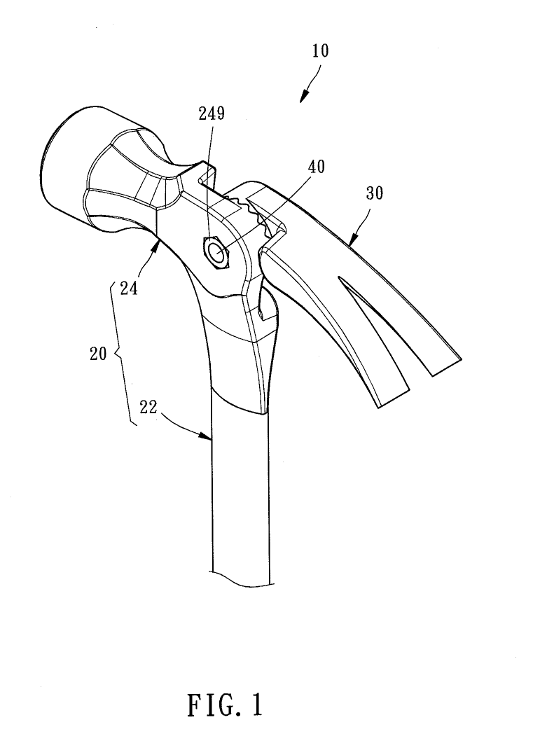

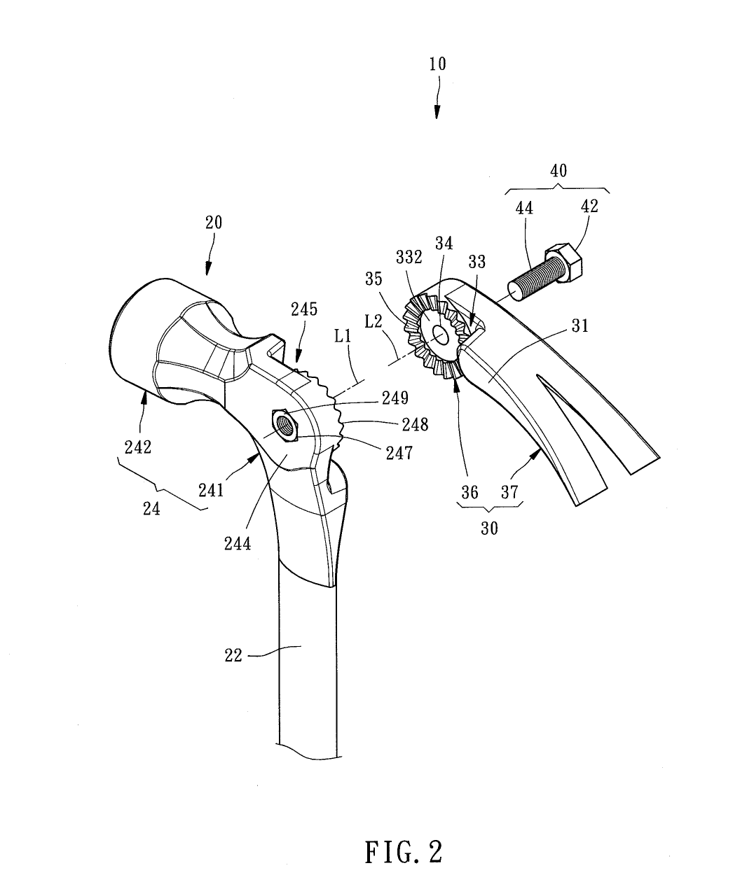

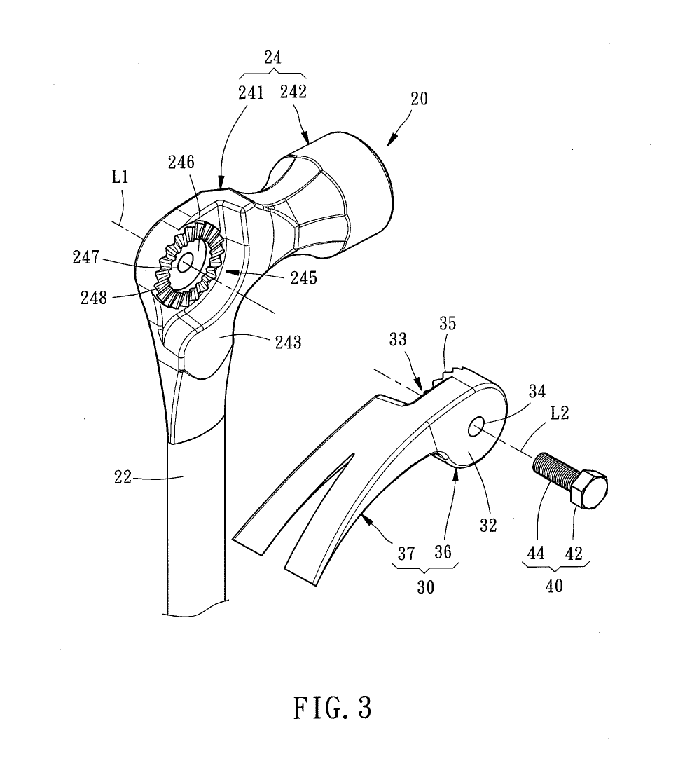

Referring to FIG. 1 to FIG. 3, a claw hammer 10 capable of adjusting an angle according to a first preferred embodiment of the present invention comprises a body 20, a nail-drawing piece 30 and a fixing piece 40.

The body 20 has a handle rod 22 and a hammerhead 24 which is integrally connected to an end of the handle rod 22; and the handle rod 22 and the hammerhead 24 are not limited to being integrally formed provided that they are fixed to each other. The hammerhead 24 has a joining section 241 and a hammering section 242 which transversely extends outwards from the joining section 241; and the handle rod 22 longitudinally extends outwards from the joining section 241. In other words, the hammerhead 24 and the handle rod 22 are substantially perpendicular to each other. The joining section 241 has two side surfaces 243, 244 opposite to each other, a recess portion 245 recessed from the side surface 243, a through hole 247 which extends through the side surface 244 and a bottom surface 246 of the recess portion 245, and a tooth portion 248 which protrudes from the bottom surface 246 and is distributed in a circular form about a central axis L1 of the through hole 247. Furthermore, a nut 249 is further fixedly disposed in the through hole 247.

The nail-drawing piece 30 has two side surfaces 31, 32 opposite to each other, a recess portion 33 recessed from the side surface 31, a through hole 34 which extends through the side surface 32 and a bottom surface 332 of the recess portion 33, and a tooth portion 35 which protrudes from the bottom surface 332 and is distributed in a circular form about a central axis L2 of the through hole 34. The nail-drawing piece 30 may be divided into a joining section 36 having the recess portion 33 and the tooth portion 35, and a nail-drawing section 37 in a fork form.

The fixing piece 40 is a bolt, and has a head 42 and a threaded rod 44.

During assembly of the claw hammer 10, the tooth portion 248 of the hammerhead 24 and the tooth portion 35 of the nail-drawing piece 30 engage with each other with the central axes L1, L2 coinciding with each other. Then, the threaded rod 44 of the fixing piece 40 extends through the through hole 34 of the nail-drawing piece 30 and is threaded to the nut 249 of the hammerhead 24. Thereby, the joining section 36 of the nail-drawing piece 30 is clamped between the joining section 241 of the hammerhead 24 and the head 42 of the fixing piece 40. In this way, the nail-drawing piece 30 is fixed to the body 20, and the user can hold the handle rod 22 to draw a nail (not shown) out of an object (not shown) by means of the nail-drawing section 37 of the nail-drawing piece 30.

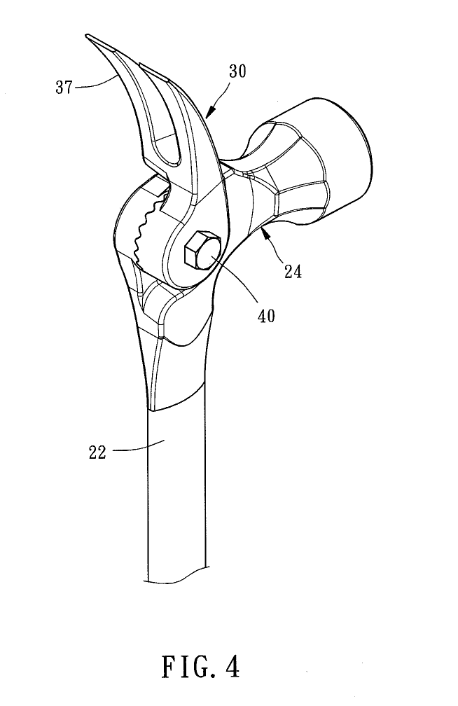

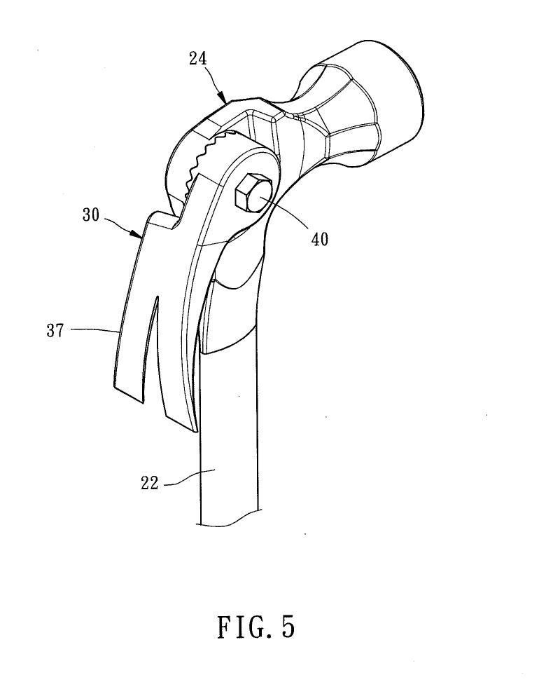

More importantly, the user can adjust a relative angle between the nail-drawing piece 30 and the hammerhead 24 by loosening the fixing piece 40 and disengaging the tooth portion 35 of the nail-drawing piece 30 from the tooth portion 248 of the hammerhead 24. When the nail-drawing piece 30 and the hammerhead 24 are connected into an aspect as shown in FIG. 1, the structure formed by the nail-drawing piece 30 and the hammerhead 24 connected together is similar to a conventional hammerhead. The user can change the angle of the nail-drawing piece 30 with respect to the body 20 in the aforesaid way so that the nail-drawing section 37 of the nail-drawing piece 30 is further away from the handle rod 22 (e.g., the aspect shown in FIG. 4) or closer to the handle rod 22 (e.g., the aspect shown in FIG. 5). In this way, the angles of the nail-drawing piece 30 with respect to the hammerhead 24 and with respect to the handle rod 22 will vary with the angle of the nail-drawing piece 30 so that the relative relationship between a direction in which the user applies a force on the handle rod 22 and a direction in which the nail-drawing piece 30 applies a force on the nail also varies accordingly. Thereby, as compared to the conventional claw hammer, the claw hammer 10 is more suitable for use in a space which is narrow or has an obstacle therein.

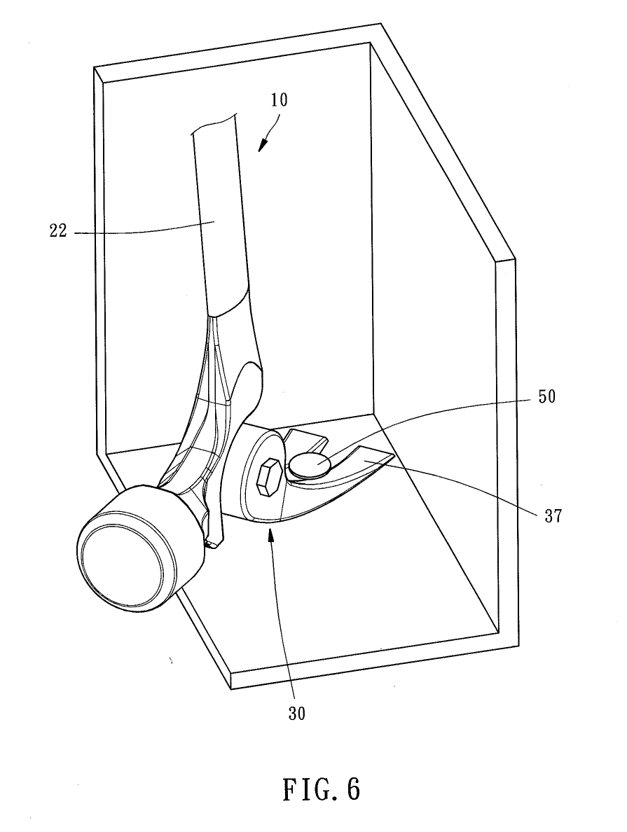

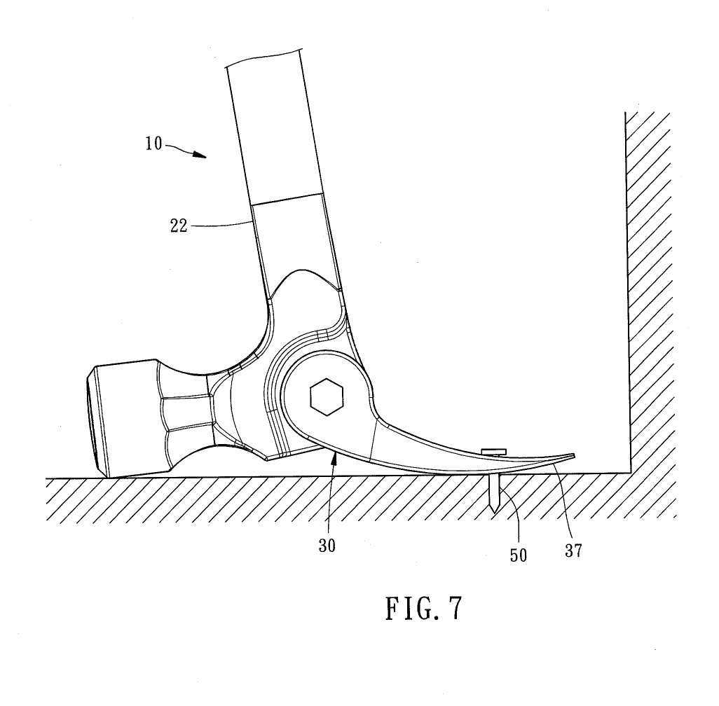

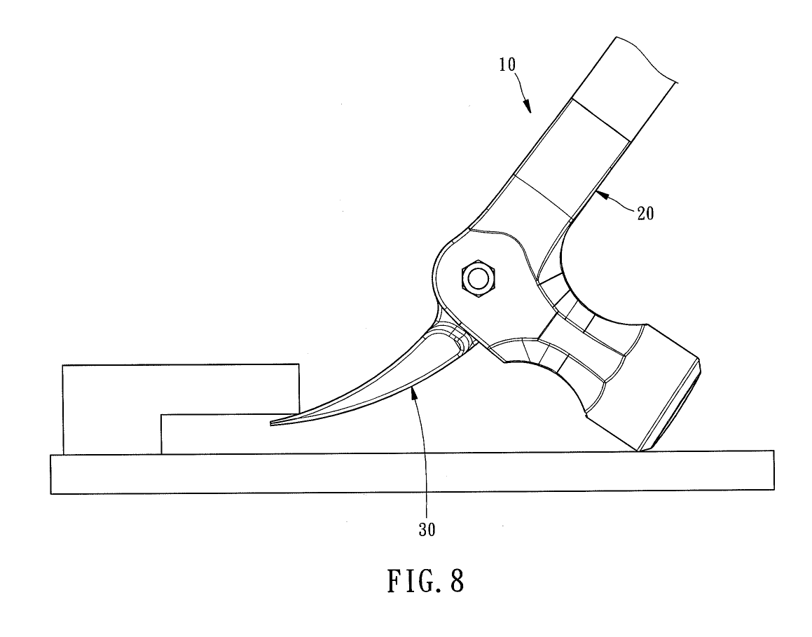

For example, as compared to the aspect shown in FIG. 1, the nail-drawing section 37 of the nail-drawing piece 30 of the claw hammer 10 shown in FIG. 6 and FIG. 7 is slightly far away from the handle rod 22, so it can be used to draw a nail 50 which is relatively close to the corner of the wall, and is relatively convenient in use. In addition, when the nail-drawing piece 30 of the claw hammer 10 is in the aspect shown in FIG. 8, the claw hammer 10 has the functions of a tommy bar.

In the aforesaid embodiment, the joining section 241 of the hammerhead 24 is disposed in the recess portion 33 of the nail-drawing piece 30 and the joining section 36 of the nail-drawing piece 30 is disposed in the recess portion 245 of the hammerhead 24, so the nail-drawing piece 30 and the hammerhead 24 will not result in too large volume and thickness due to superposition thereof, which can avoid causing obstruction in use of the claw hammer 10. However, neither the hammerhead 24 nor the nail-drawing piece 30 is limited to having a recess portion.

In the aforesaid embodiment, when the user draws the nail by means of the nail-drawing piece 30 by swinging the claw hammer 10, the engagement between the tooth portion 248 of the hammerhead 24 and the tooth portion 35 of the nail-drawing piece 30 can further ensure that the nail-drawing piece 30 will not rotate with respect to the body 20 in the nail drawing process. However, there is no need for the hammerhead 24 and the nail-drawing piece 30 to rotate by 360° with respect to each other, so the tooth portions 248, 35 of the hammerhead 24 and the nail-drawing piece 30 may also be distributed in an arc form rather than the circular form. Further, the way in which the fixing piece 40 fixes the nail-drawing piece 30 to the body 20 is not limited to what described in the aforesaid embodiment either; that is, the fixing piece 40 is not limited to being a bolt, and the body 20 may not be provided with the nut 249 either.

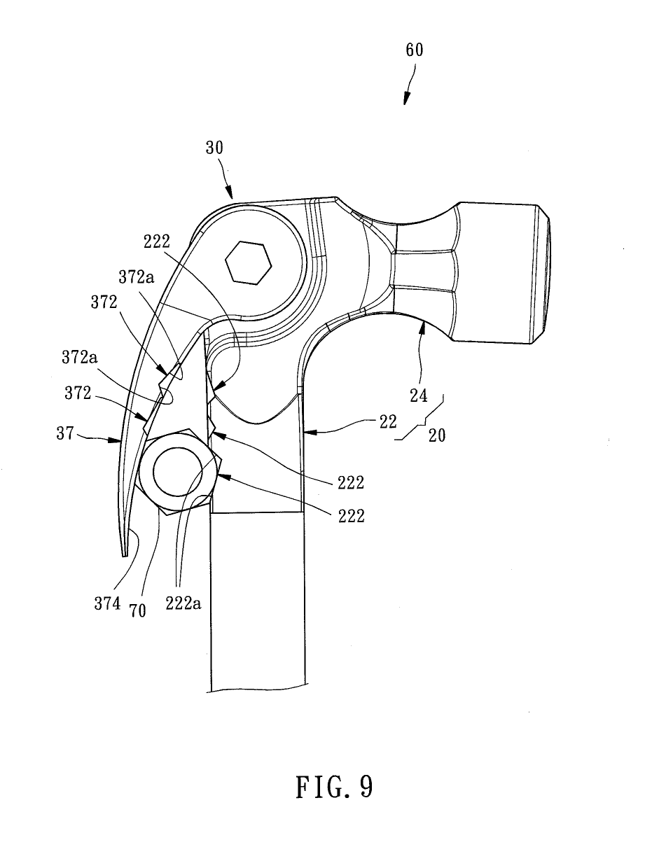

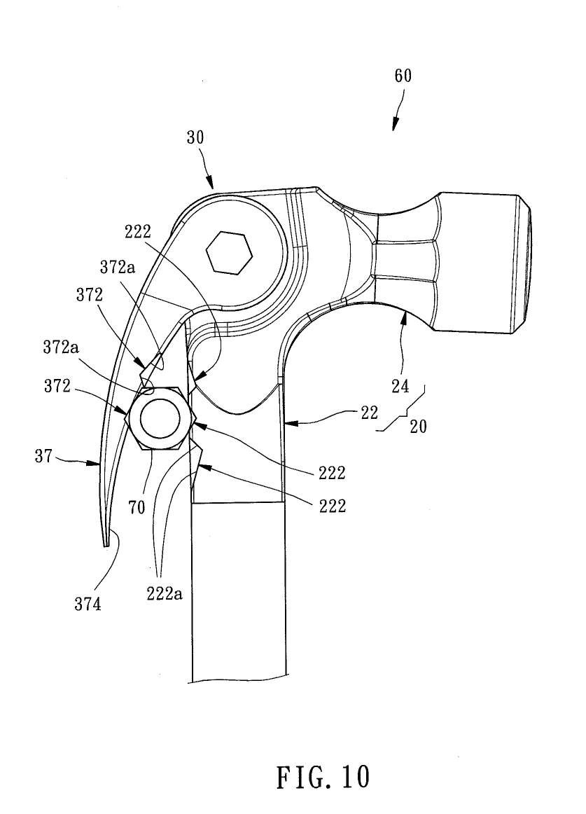

Referring to FIG. 9 and FIG. 10, a claw hammer 60 capable of adjusting an angle according to a second preferred embodiment of the present invention differs from the aforesaid claw hammer 10 in that: the handle rod 22 of the body 20 of the claw hammer 60 is further provided with three clamp grooves 222, the nail-drawing section 37 of the nail-drawing piece 30 of the claw hammer 60 is further provided with two clamp grooves 372, and each of the clamp grooves 222, 372 has two clamp surfaces 222a, 372a which include an angle of about 120° therebetween. Thereby, when the nail-drawing piece 30 is rotated to predetermined angles as shown in FIG. 9 and FIG. 10 with respect to the body 20, the claw hammer 60 can be used to clamp an object 70, which is a nut, between the clamp grooves 222 of the body 20 and the clamp grooves 372 of the nail-drawing piece 30 (as shown in FIG. 10) or between the clamp grooves 222 of the body 20 and a surface 374 of the nail-drawing section 37 (as shown in FIG. 9). In this case, the claw hammer 60 can be used as a spanner, and the clamp grooves 222 of the body 20 can be used to clamp objects 70 of different sizes (the object 70 of FIG. 10 is smaller in size than the object 70 of FIG. 9). The forms and the numbers of the clamp grooves 222, 372 are not limited to what described in this embodiment, and the object 70 is not limited to being a nut either.

Finally, it shall be appreciated again that, the elements disclosed in the aforesaid embodiments of the present invention are only illustrative but are not intended to limit the scope of the present invention, and replacements or variations of other equivalent elements shall also fall within the scope of the appended claims.

What is claimed is:

1. A claw hammer capable of adjusting an angle, comprising:
a body, having a handle rod and a hammerhead connected to the handle rod, the hammerhead having a central axis and a tooth portion distributed about the central axis;
a nail-drawing piece, having a joining section and a nail-drawing section which are connected to each other, the joining section having a central axis and a tooth portion distributed about the central axis, and the tooth portion of the nail-drawing piece being engaged with the tooth portion of the body; and
a fixing piece, being disposed in the nail-drawing piece and the body so that the nail-drawing piece and the body are fixed to each other.

2. The claw hammer capable of adjusting an angle of claim 1, wherein the hammerhead of the body has two side surfaces opposite to each other and a recess portion recessed from one of the side surfaces, the recess portion has a bottom surface, and the tooth portion of the hammerhead protrudes from the bottom surface.

3. The claw hammer capable of adjusting an angle of claim 1, wherein the nail-drawing piece has two side surfaces opposite to each other and a recess portion recessed from one of the side surfaces, the recess portion has a bottom surface, and the tooth portion of the nail-drawing piece protrudes from the bottom surface.

4. The claw hammer capable of adjusting an angle of claim 1, wherein the tooth portion of the hammerhead of the body is distributed in a circular form.

5. The claw hammer capable of adjusting an angle of claim 1, wherein the tooth portion of the nail-drawing piece is distributed in a circular form.

6. The claw hammer capable of adjusting an angle of claim 1, wherein the fixing piece extends through the nail-drawing piece and is threaded to the body.

7. The claw hammer capable of adjusting an angle of claim 1, wherein the handle rod of the body is provided with a clamp groove, and the claw hammer is capable of clamping an object between the clamp groove and the nail-drawing section of the nail-drawing piece when the nail-drawing piece is rotated to a predetermined angle with respect to the body.

8. The claw hammer capable of adjusting an angle of claim 1, wherein the nail-drawing section of the nail-drawing piece is provided with a clamp groove, and the claw hammer is capable of clamping an object between the clamp groove and the handle rod of the body when the nail-drawing piece is rotated to a predetermined angle with respect to the body.

9. The claw hammer capable of adjusting an angle of claim 1, wherein the handle rod of the body is provided with a plurality of clamp grooves, the nail-drawing section of the nail-drawing piece is also provided with a plurality of clamp grooves, the claw hammer is capable of clamping an object between the clamp grooves of the body and the clamp grooves of the nail-drawing piece or a surface of the nail-drawing section when the nail-drawing piece is rotated to a predetermined angle with respect to the body, and the clamp grooves of the body are adapted to clamp objects of different sizes.

10. The claw hammer capable of adjusting an angle of claim 9, wherein each of the clamp grooves has two clamp surfaces which include an angle of about 120° therebetween.
